(19) United States
(12) Patent Application Publication
(10) Pub. No.: US 2026/0243431 A1
(43) Pub. Date: Aug. 20, 2026

(54) BIOMASS HEATER SYSTEM AND METHOD

(71) Applicant: THE RESEARCH FOUNDATION FOR THE STATE UNIVERSITY OF NEW YORK, Albany, NY (US)

(72) Inventors: Dimitris ASSANIS, Stony Brook, NY (US); Jon LONGTIN, Port Jefferson, NY (US); Jason LOPRETE, Stony Brook, NY (US)

(73) Assignee: THE RESEARCH FOUNDATION FOR THE STATE UNIVERSITY OF NEW YORK, Albany, NY (US)

(21) Appl. No.: 19/469,616

(22) PCT Filed: Mar. 27, 2024
(86) PCT No.: PCT/US2024/021719

§ 371 Date: Sep. 26, 2025

Related U.S. Application Data
(60) Provisional application No. 63/492,316, filed on Mar. 27, 2023.

(51) Int. Cl. F24B 1/02; G05B 13/02

(52) U.S. Cl. CPC F24B 1/028; G05B 13/0265

(57) ABSTRACT

A biomass heater system and method, in particular, an intelligent biomass heater utilizing a minimal set of measurement sensors and a control strategy to actively modulate incoming air, enhancing stove combustion performance, and thereby eliminating user-error as a factor for emissions production. The heater implements methods to estimate critical performance metrics such as the heat release rate, instantaneous stove efficiency, combustion stoichiometry and biomass fuel moisture content using combinations of sensor reading such as the heater temperature, weight and airflow rates. These parameters are used in a feedback control algorithm to optimize the variable application of combustion air and reduce the burden on the operator by providing recommendations for refueling and replacement of components through automated, intelligent decision-making. The applied approach uses a combination of deep learning Neural Networks, Classification Models, and Reinforcement Learning to allow for a continuous prediction of emissions and operation mode and provide appropriate actuator adjustment.

### CROSS REFERENCE TO RELATED APPLICATIONS

This application claims the benefit of U.S. Provisional Application No. 63/492,316 filed on Mar. 27, 2023, the entirety of which is incorporated by reference.

### FIELD

The present application relates generally to a biomass combustion appliance, e.g., stoves (or ovens), boilers, heaters, and particularly, wood burning stoves, heaters or like devices or like appliances that generate energy from like organic materials, and more particularly, relates to an automated method for improving device conditions to maximize efficiency and minimize emissions of such biomass heater systems.

### BACKGROUND

Wood combustion is one of the oldest forms of space heating, persisting and evolving throughout human history. Today, modern forms of wood-based space heating consist of wood-fired hydronic heating devices and woodstoves. In the residential sector, these devices along with other uses of wood combustion are responsible for less than a percent of the United State's primary energy consumption but are the largest source of the nation's primary PM2.5 emissions (where particulate matter (PM) such as PM2.5 indicates particle emissions less than 2.5 micrometers in diameter and measured in #/cm3). Emissions from woodstoves are often due to incomplete combustion as a result of: poor mixing, low chamber temperatures, low residence times of the fuel/air mixture, and an overall lack of available oxygen.

With residential wood combustion only growing in popularity in the Northeastern United States, there exists a need to develop new techniques to reducing emissions in this sector. Many technological advances have been made in wood-based space heaters throughout the years that have aided in emissions reduction. Pellet stoves and boilers rely on pre-processed fuels and are automatically fed, which adds a layer of control and allows for more consistent combustion. However, most cordwood stoves on the market remain reliant on manual intervention and utilize fuel that can differ in species, geometry, and moisture content.

Differences in fuel characteristics combined with operator error encourages incomplete combustion due to inadequate air supply and improper refueling. Proper operation and avoidance of unfavorable burn conditions itself is of higher importance than fuel species in reducing emissions. These factors alone produce more emissions than what is encountered during certification testing, and thus the real-world emissions may be orders of magnitude higher than what is predicted using currently allowable upper limits defined by the United States' Environmental Protection Agency. As a result, lowering emissions from cordwood stoves in particular is of primary importance as these devices continue to become more prominent as a form of residential space heating.

Much effort has already gone into reducing emissions from cordwood stoves. While several modeling approaches have been utilized, the physical phenomena are extremely complex and processes operate over different time scales. For example, a wood log takes minutes to fully go through pyrolysis, while turbulence variations take place over fractions of a second. Modeling the surface reactions, fluid flow, and gas reactions each accurately is difficult, and approximations or empirical relations are often used to reduce computational demands. However, a complete, state-of-the-art model has not yet been developed to address all components of wood combustion, and as a result much of the improvements in the field have been limited to experimental studies. A common approach is the development of secondary and tertiary air flow paths in modern stoves to allow for the introduction of additional oxygen during certain periods of operation to enhance performance and reduce emissions.

There has been investigated low-cost retrofit devices that introduce pre-heated alternative secondary air for older devices and found an increase in thermal efficiency from 62% to 79%, as well as reduced emissions. Their findings showcase the magnitudes of the effects secondary air optimization has on stove performance. However, stove manufacturers differ greatly in their placement of primary and secondary air inlets, and developing a retrofit device compatible with a variety of existing stove models may be cumbersome. Another retrofit study performed incorporating heat exchangers and exhaust fans found improvements in emissions as well but found that combining the two approaches can lead to adverse interactions and increased PM cmissions. This indicates that there is a delicate balance that must be maintained for devices, and is difficult to maintain without additional feedback mechanisms.

Furthermore, woodstoves are known to have a wide range of values for performance and emissions depending on operating conditions, making it difficult to have a one-size fits all solution if the solution is not adaptive. Additional techniques, such as utilizing porous ceramics in the combustion chamber, have found a 20% decrease in PM emissions, attributed an increase in volatile compound interactions. Furthermore, catalytic combustors are often used as a secondary emissions measure, but are limited by high flue-gas temperature requirements.

Further, many existing methods work well to reduce emissions in their given setup, but are often inflexible in that they either only affect a specific combustion regime, or are difficult to be adapted to a variety of existing and new stove designs.

A need thus exists for automated applications to identify a minimal set of sensors to characterize combustion performance that does not rely on laboratory grade measurement tools.

Most cordwood stoves on the market today rely solely on manual control and user-errors lead to unfavorable burn conditions (i.e., smoldering). For example, most cordwood stoves include manual controls such as airflow controls (dampers), fuel charge loading/placement, stoking (e.g., adjusting coals). Operator experience influences performance (e.g., how much, where, and when is fuel or air to be added?). Further, there is so much variability in moisture content, fuel geometry, and fuel-type that there does not exist a one-size fits-all solution in terms of combustion chamber design.

Additionally, wood-burning stove devices and controls are prone to user-error, which exasperates unfavorable burn conditions. For example, in-field operation deviates from certification testing due to transient real-world operations (e.g., wet wood, irregular refueling intervals, etc.) causing 100x increase in emissions. For example, current wood burning systems may utilize a static lookup table of different parameters to determine operation mode and offer the user guidance. These lookup tables are a finite mapping of inputs to outputs and do not change unless the device receives a software update. They then must rely on simple extrapolation when faced with an environment not within the bounds of the table. This potentially leads to poor performance as the device ages and encounters burn situations not foreseen by the table's creators.

### SUMMARY

Embodiments of the invention described herein provide an intelligent biomass heater system and method.

With more particularity, there is provided an intelligent biomass heater or stove that utilizes a minimal set of measurement sensors, actuators and controls to actively modulate and enhance stove combustion performance while minimizing emissions.

In a further aspect, there is provided an intelligent biomass heater/stove utilizing a minimal set of measurement sensors and a control strategy to actively modulate incoming air, thereby enhancing stove combustion performance, thereby eliminating user-error as a factor for emissions production.

In a further aspect, the intelligent stove provides processing to estimate critical derived performance metrics such as the heat release rate, instantaneous stove efficiency, combustion stoichiometry and wood moisture content using combinations of the stove temperature, weight and airflow rates as sensed by sensor devices at the stove.

In an embodiment, these metrics are used in a feedback control algorithm to optimize the variable application of combustion air as well as reduce the burden on the operator by providing recommendations for refueling and replacement of components through automated, intelligent decision-making.

Accordingly, disclosed is a biomass combustion apparatus and method of operating a biomass combustion appliance that provide improved emissions performance in the respect of maximizing efficiency while minimizing emissions.

In an example embodiment, the biomass combustion appliance and method of operating achieves improved efficiency by minimizing unburned fuel lost through stack (CO and volatile hydrocarbons) by maximizing combustion efficiency. To achieve improved efficiency, the amount combustion air is optimized such that there is just enough excess air to ensure complete combustion. Other interpretations of “combustion efficiency” also known as device “conversion efficiency” more broadly can mean the efficiency of generating heat from a given amount of biomass, or the efficiency of how long or short one can utilize the batch of biomass in the combustion chamber. These various efficiencies can be used as target conditions/metrics for the algorithm.

In an example embodiment, the wood burning stove and method of operating achieves improved efficiency by optimizing excess combustion air, which is heated in the stove, but does not contribute to room heat, and ensures combustion stoichiometry. To achieve improved efficiency, the amount combustion air is reduced, and the system indicates a best time for a re-fueling to avoid combustion in regimes below a minimum air-delivery rate.

In a further example embodiment, the wood burning stove and method of operating achieves improved efficiency by minimizing the stack temperature, while ensuring complete wood combustion. To achieve improved efficiency, the amount combustion air is reduced.

Similarly, in embodiments, the wood burning stove and method of operating achieves reduced emissions such as particulate matter (PM) by avoiding a smoldering condition in which combustion is starved for air. To achieve reduced emissions, the amount of combustion air is increased, and the system and method detects a time to generate a warning for an operator to avoid an over-fueling condition.

In a further example embodiment, the wood burning stove and method of operating achieves reduced emissions by minimizing a cold-start and hot refuel times. To achieve reduced performance, the amount combustion air is maximized.

Yet in a further embodiment, the intelligent stove for controlling biomass combustion uses an approach that combines use of Deep Learning Neural Networks, Classification Models, and Reinforcement Learning to allow for a continuous prediction of emissions and operation mode, as well as appropriate actuator adjustment, due to its ability to adapt to new stove operation situations.

Critical performance metrics such as the heat release rate, instantaneous stove efficiency, combustion stoichiometry and wood moisture content can all be estimated using combinations of the stove temperature, weight and airflow rates.

In accordance with a first aspect of the invention, there is provided an apparatus for controlling a biomass combustion appliance. The apparatus comprises: one or more sensor devices associated with the biomass combustion appliance, said one or more sensor devices placed at predetermined locations on the biomass combustion appliance for sensing real-time biomass conversion operating conditions and also generating corresponding sensor signals; a hardware processor configured to receive said real-time sensor signals associated with said real-time biomass fuel conversion operating conditions, predict a trajectory of the real-time signals and derive performance characteristic parameters associated with a current biomass fuel combustion operating conditions based on said real-time sensor signals, and the hardware processor further configured to generate, based on the derived performance characteristic parameters and predicted trajectory of the one or more real-time sensor signals, a predictive-based control signal for modifying an amount of combustion air introduced for biomass combustion at said biomass combustion appliance, said amount of combustion air modified in a manner to achieve a desired combustion operation.

Further to this aspect, the predictive-based control signal modifies one or more other critical combustion operating parameters to achieve desired combustion operation.

In a further aspect, there is provided a method for controlling a biomass combustion appliance. The method comprises: sensing, using one or more sensor devices placed at predetermined locations on a biomass combustion appliance, real-time biomass combustion operating conditions and generating corresponding sensor signals; receiving, at a hardware processor, said real-time sensor signals associated with said real-time biomass combustion operating conditions; predicting, by the hardware processor, a biomass operating condition/parameter trajectory of one or more real-time sensor signals; deriving, by said hardware processor, performance characteristic parameters associated with a current biomass combustion operating condition based on said real-time sensor signals, and generating, based on the derived performance characteristic parameters and/or the determined forecasted biomass operating condition/parameter trajectory, a control signal for modifying an amount of combustion air in a manner to achieve a desired combustion operation.

Further to this aspect, the predictive-based control signal modifies one or more other critical combustion operating parameters to achieve desired combustion operation.

In a further aspect, the hardware processor can be further configured to generate, based on the real-time biomass operating conditions and the past history of the real-time biomass operating conditions, a forecasted or expected real-time biomass operating condition/parameter trajectory.

In a further aspect, the predictive-based control signal for modifying an amount of combustion air or one or more other critical combustion operating parameters introduced for wood combustion at said biomass combustion appliance, modifies the amount of combustion air or other critical combustion operational parameter(s) in a manner to improve a biomass combustion efficiency or reduce gaseous or solid particulate emissions produced by the biomass combustion.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIGS. 1A-1C illustrate example plots depicting the experimental burning conditions of wood fuel in a wood burning stove;

FIG. 2 is a schematic depiction of a smart or intelligent biomass (e.g., wood) burning heater or stove (an “appliance”) according to an embodiment;

FIG. 3 provides a chart depicting types of fundamental parameters and examples of their derived performance characteristics;

FIG. 4 illustrates an exemplary wood burning stove apparatus in accordance with an experimental use;

FIGS. 5A, 5B and 5C depict stack velocity, stove weight, and stove temperature trends over a representative burn case;

FIG. 6 depicts a chart indicating the approach for developing a method for controlling biomass heater/stove operations to effect maximized burning efficiency with minimized emissions;

FIG. 7 depicts an approach for developing a method for controlling biomass heater/stove operations to maximize burning efficiency with minimum emissions at a wood burning stove using a minimum of sensing parameters;

FIG. 8 depicts a further process for generating a wood burn emission control model for predicting particulate emissions for particular stove settings and provide reinforcement learning for taking a corrective approach to optimize combustion and minimize generating particulate matter at the stove; and

FIG. 9 depicts an exemplary method for wood burn stove emission control for implementing a corrective approach to optimize combustion and minimize generating particulate matter at the stove.

### DETAILED DESCRIPTION

The following detailed description of aspect of the disclosure will be made in reference to the accompanying drawings. In this disclosure, explanation about related functions or constructions known in the art are omitted for the sake of clearness in understanding the concept of the disclosure to avoid obscuring the disclosure with unnecessary detail.

The present disclosure provides for a solution to mitigate the efficiency and emissions problems due to inadequate controlling of combustion air when converting (e.g., burning) wood (e.g., firewood, cordwood, cribwood, pellets, saw dust, wood chips, wood chunks, wood products) or other organic materials in biomass heaters/stoves (“appliances”).

In an embodiment, there is provided an intelligent stove utilizing a minimal set of measurement sensors and a control strategy to actively modulate incoming air, enhancing stove combustion performance using low-cost sensors in an effort to reduce emissions thereby eliminating user-error as a factor for emissions production.

Critical performance metrics such as the heat release rate, instantaneous stove efficiency, combustion stoichiometry and wood moisture content data can all be estimated using combinations of the stove temperature, weight and airflow rates data. These performance parameters are then used in a feedback control or wood burn emission control algorithm to optimize the variable application of combustion air as well as reduce the burden on the operator by providing recommendations for refueling and replacement of components through automated, intelligent decision-making. In embodiments, device conversion efficiency or other interpretations of “combustion efficiencies” more broadly can mean the efficiency of generating heat from a given amount of wood, or the efficiency of how long or short one can utilize the batch of biomass in the combustion chamber. These various efficiencies can be used as target conditions/metrics for the algorithm.

In an embodiment, an intelligent smart woodstove apparatus and method of operation causes the actuation of relevant tools (e.g., DC servo connected to air damper/small variable speed axial fan) to modulate the combustion airflow according to the wood burn emission control algorithm to ensure an inlet airflow is high enough to supply adequate oxygen. In an embodiment, a microcontroller can process the data and actuate the relevant tools, such as a DC servo connected to air damper or small variable speed axial fan, to modulate the combustion airflow according to the wood burn emission control algorithm. This acts to ensure the inlet airflow is high enough to supply adequate oxygen and encourage more complete combustion throughout all burn phases, especially during start-up and burn out phases which are known to produce more emissions. The provisions of intelligence with a heuristic control strategy and a microprocessor can ensure maximized wood burning efficiencies that minimizes emissions.

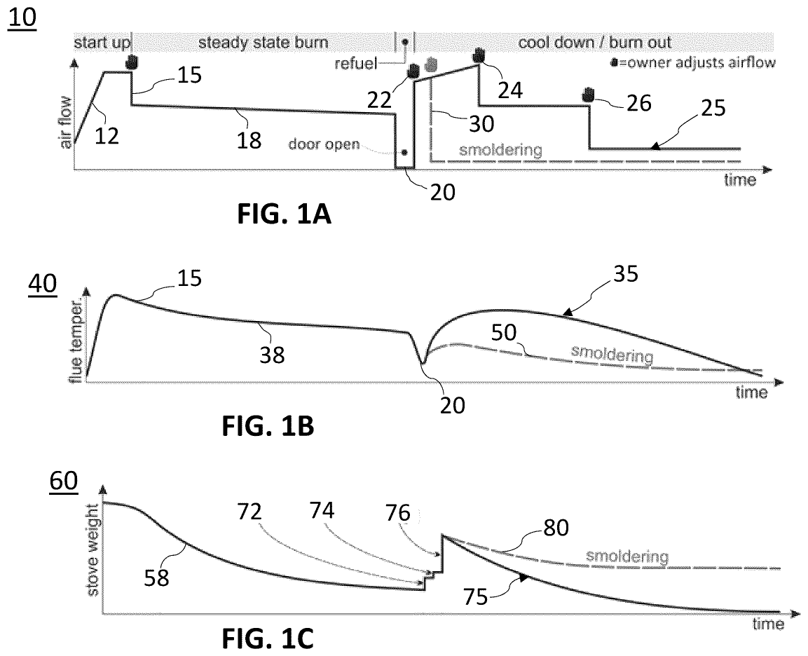

FIGS. 1A-1C illustrate example plots depicting the experimental burning conditions of a biomass fuel in a biomass combustion appliance including a wood burning stove, pellet burning stove, wood burning hydronic boiler, and the like.

FIG. 1A particularly shows a plot 10 of the air flow versus time in a wood burning stove that is burning wood under manual control in an experimental use. After a start up time period 12 where airflow is ramped up and after a time of a manual airflow adjustment as indicated at 15 there is a fairly steady state burn 18 until such time as when the door is manually opened to “refuel” by adjusting air flow at a manually determined “refuel” time as shown at time 20. After such refueling, subsequent manual airflow adjustments performed at indicated times 22, 24, 26 reveal a corresponding cool down, burn out characterization represented as the plot 25 of air flow vs. time. The representative real-world wood burn smoldering conditions represented vs time by plot 30 deviate from desired operating conditions over the remainder of the wood stove's wood burn duration.

FIG. 1B shows a plot 40 of the flue temperature versus time in the wood burning stove that is burning wood under manual airflow control as indicated at times shown in the air flow plot 10 of FIG. 1A. From the end of the start up time at the first manual airflow adjustment performed at time 15 there is a fairly steady state burn 38 until such time as when the stove door is again manually opened to “refuel” by adjusting air flow as shown at about time 20. As a result of further re-fueling and manual airflow adjustments at times 22, 24 and 26, there results the plot 35 of corresponding flue temperature plot vs. time. This plot 35 shown in FIG. 1B compared to representative real-world wood smoldering conditions over time as represented by plot 50 reveal a deviation from desired operating conditions over the remainder of the wood stove's wood burn duration.

FIG. 1C shows a plot 60 of the stove weight versus time in a wood burning stove that is burning wood under manual control as indicated at times shown in the air flow plot 10 as a function of time as shown in FIG. 1A. From the start up time up until such time as when the door is manually opened to “refuel” at about time 20, there is a noticeable decrease 58 in stove mass as the fuel is consumed. At about a refueling time 20, three different-sized logs are added to the stove in a sequence with a moderate-sized log added at 72, a small log added at 74 and a large-sized log added at 76 at which time the weight of the stove has increased. As shown in FIG. 1C, there is a fairly steady state burn 75 until the fuel is burned. The representative real-world wood smoldering conditions represented in time by plot 80 deviate from desired operating conditions over the remainder of the wood stove's wood burn duration.

Emissions from wood combustion arise due to variety of different mechanisms. The majority of emissions, however, may be attributed to incomplete combustion due to a lack of available oxygen, poor mixing, low residence times of the fuel-air mixture, and low chamber temperatures, which influences the rates of intermediary reactions. Rather than focus on a series of intermediary reactions, wood combustion may instead be approximated using the chemical reaction described by Eqn. (1) as follows:

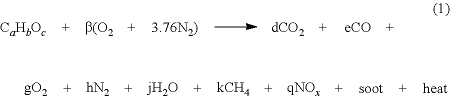

There thus exists a defined amount of oxygen relative to fuel consumed required to ensure complete combustion. By measuring the stove weight in real time, the present method computes how quickly fuel is consumed by the appliance and therefore how much oxygen is required at a given instance. This deviates from traditional stove performance, where an operator may “set and forget” the inlet air control or other critical combustion operating parameter, thereby affecting the combustion process such as over or under oxygenating the fuel throughout the combustion process. With most critical combustion operating parameters, defined as parameters that have the ability to affect the combustion process, such as combustion air, there is an optimum required oxygen supply rate to achieve a specified excess air-ratio, defined by Eqn. (2), that may be determined and prescribed for favorable combustion. For example, a higher excess air ratio can result in lower CO emissions and as a result this derived parameter may be utilized in the wood burn emission control algorithm's decision-making matrix.

$$EA = \frac{{β}_{actual}}{{β}_{stoichiometric}} \qquad ( 2 )$$

where EA is the Excess Air Ratio, β_{stoichiometric} is stoichiometric airflow (mols) and β_{actual} is the actual airflow (mols).

By incorporating an airflow measurement, the wood burn emission control algorithm can determine how much air is being supplied and whether or not this amount is sufficient. However, further indicators are required to determine how much oxygen is sufficient. The best available indicator of this is the combustion chamber temperature. Yet, direct measurement of the combustion chamber temperature is difficult due to sensor longevity in such a harsh environment. For this, the present method utilizes flue gas and jacket temperatures as proxy measurements to help identify the combustion regime.

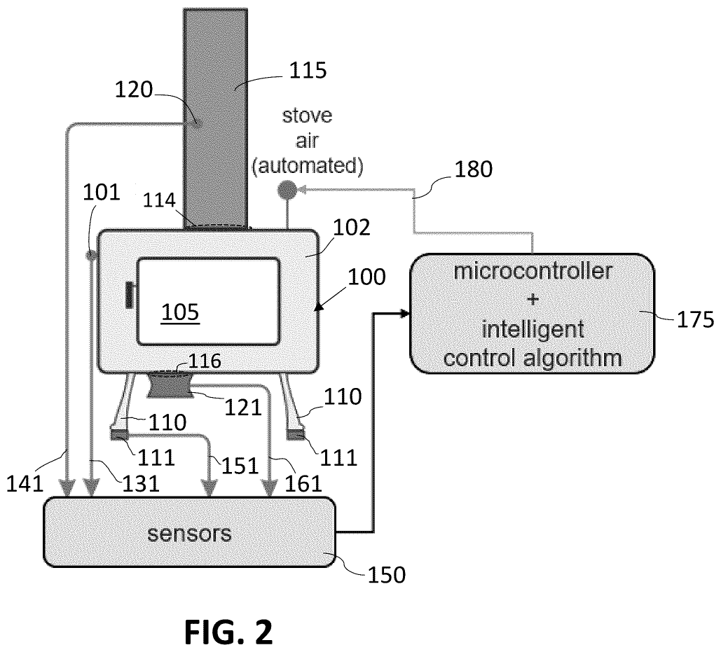

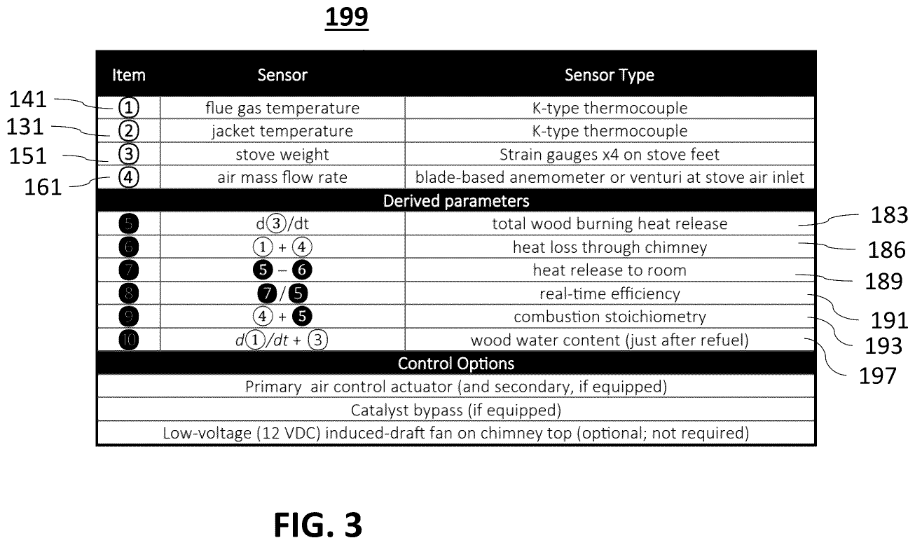

As an example, a typical biomass (e.g., wood) burn consists of an initial torrefaction phase, where the drying and devolatilization of the fuel occurs, followed by pyrolysis in oxygen deficient areas, gasification, and eventually, full combustion. The initial drying phase may be determined through fitting the stove weight curve on the fly, as there have been identified an initial linear decrease in mass during this phase. In principle, the combination of this fundamental set of parameters could then be used to estimate the initial moisture content of the wood according to FIG. 3 depicting the types of fundamental parameters and their derived performance characteristics and alert the operator for future runs if the fuel charge utilized was too wet or dry, as well as provide recommendations for refueling events. Further specifications of the combustion regime will then make use of the flue and jacket temperatures, with certain thresholds corresponding to corresponding to different phases of the burn process. A layout of the aforementioned sensors is illustrated in FIG. 2 and is used as a basis for the system.

FIG. 2 is a schematic depiction of a smart or intelligent biomass (e.g., wood) burning heater or stove (e.g., or alternatively an “appliance”) 100 according to an embodiment of the disclosure. The stove 100 includes a jacket or housing 102 that defines an interior fuel burning chamber within which fuel materials are placed for burning. A front-facing door 105 is operable to allow entry of fuel materials (e.g., biomass, wood logs, bricks, kindling) into the combustion chamber. The stove 100 is shown as supported by one or more legs 110. The stove is shown with an adjustable airflow opening 114 connecting a top portion of the stove's wood burning chamber to a flue or stack 115 connecting to an external chimney via which wood burning stove exhaust and emissions flow out of. Additionally provided underneath the stove's fuel combustion (e.g. burning) chamber through the housing is a further adjustable airflow opening 116 which adjustable opening can be programmable to provide variable amounts of airflow into the stove 100. Adjustable airflow openings 114, 116 can include a plate, a door, a grating, a vent, a baffle, a louver(s), thermally expanding material, etc. and including a programmable actuator that can be configured to vary the degree of openings 114, 116, e.g., for adjusting airflow into the chamber. Additional components such as a variable speed fan, a blower, a controllable damper, a catalytic combustor can also be provided with a passive or active adjustable actuator that operate to modulate/alter airflow or other critical combustion operating parameters at the biomass combustion appliance (e.g. wood burning stove). For example, to adjust combustion air, the air flow damper can be provided with a feedback control signal that is adapted to modify an amount of combustion air introduced to the wood burning stove. Similarly, the wood burning stove can include a DC servo motor connected to the air flow damper that can be provided with a feedback control signal to modulate a combustion airflow at the stove. In an embodiment, the actuation device can be a linear actuator to modulate a damper or an electrified component such as a DC servo. The wood burning stove can further include a DC servo connected to a variable speed axial fan that can be provided with a feedback control signal to modulate a combustion airflow at the stove. In an embodiment, a heuristic control algorithm can generate a control signal to modify an amount of combustion air or other critical operational parameter(s) introduced into the appliance responsive to a detected biomass combustion appliance operating phase and current real-time derived performance characteristic parameters. In an embodiment, other operational parameters could mean to engage a door lock (so as at to limit the ability to reload wood), could mean to modify the amount of combustion air delivered to the combustion chamber, could mean to change the charge motion pathway of the combustion air by introducing a fan or mechanism to induce swirl or tumble motion or some combination of both, could be to introduce one or more recirculation of exhaust gasses, could be a decision of where to introduce the combustion air spatially occurs in the combustion chamber (e.g. front, back, top, bottom, sides, or combination thereof, etc.). In certain embodiments such as a wood boiler, one could use the temperature and movement of the water in the jacket of the device to control combustion chamber temperatures.

As shown in FIG. 2, situated at various locations of the stove 100 are a variety of sensor devices. Included are one or more weight sensor devices 111 located at the bottom of the legs 110 of the stove for sensing a mass of the stove and hence the mass/weight of the fuel (e.g., wood) in the chamber being/to be burned. In an embodiment, four (4) strain gauge sensors 111 are provided with each strain gauge located underneath a respective stove leg or at a stove foot to produce consistent relative measurements of the stove weight. An airflow sensor 121 is provided to monitor/control the amount and rate of airflow into the interior fuel burning chamber. This sensor 121 can include a blade-based anemometer or venturi at the stove air inlet 116 for sensing an air mass flow rate input to the wood burning chamber. A first temperature sensor device 101 is located at the stove jacket and is provided to sense the temperature of the jacket or stove housing and can include a K-type thermocouple. A second flue gas temperature sensor device 120 is provided to sense the temperature of the stack or flue 115 through which heat, gas and particulate emissions exit the stove and can also include a K-type thermocouple. The flue gas and jacket temperatures together may differentiate between cold start-up and refueling phases. A data processing device 150, e.g., interfaced with a microprocessor-based controller or like computing system 175, receives, in real-time, sensor data from each of the sensors 101, 111, 120, 121, etc. and processes the data according to develop a forecasted real-time combustion operational parameter trajectory with such information also housed in computing system 175. Additionally, the data processing device 150, e.g., interfaced with a microprocessor-based controller or like computing system 175, receives, in real-time, sensor data from each of the sensors 101, 111, 120, 121, etc. as well as the forecasted trajectories of the real-time combustion operational parameter trajectories and processes any combination of such data according to an intelligent wood burn emission control algorithm run at a microcontroller or microprocessor 175 for optimizing fuel burning and minimizing particulate matter emissions. In an embodiment, a low-cost micro-controller such as an Arduino® Mega or Raspberry Pi may be utilized in conjunction with analog-to-digital converters to provide the necessary resolution for measured parameters.

As further shown in FIG. 2, the data processing system 150 receives the stove jacket temperature sensor data 131 from jacket temperature sensor 101, receives the flue gas temperature sensor data 141 from the flue gas temperature sensor 120, receives the stove weight sensor data 151 from stove weight sensors 111, receives an air mass flow rate sensor data 161 from airflow rate sensor 121 and can receive additional information from a passive door sensor (not shown) indicating times and durations of door openings/closures of front facing door 105. Combinations of the above received sensor data can be used to compute critical performance metrics of wood stoves such as heat release rate, instantaneous stove efficiency, combustion stoichiometry, wood moisture content. Responsive to these performance metrics, according to the wood burn emission control algorithm, the microprocessor-based controller 175 can generate predicted trajectories housed in computing system 175 as well as can generate control signals 180 for controlling the conditions at the stove in a manner to reduce or minimize emissions and maximize the burning efficiency of the fuel (e.g., wood).

In an embodiment, as shown in FIG. 2, during real-time stove operations where biomass fuel, e.g., wood, is burning in the stove wood-burning chamber, the data processing system 175 receives, in real-time, the stove jacket temperature sensor data 131, the flue gas temperature sensor data 141, the stove weight sensor data 151, and an air mass flow rate sensor data 161. In an embodiment, based on the received stove jacket temperature sensor data 131, the flue gas temperature sensor data 141, the stove weight sensor data 151, and an air mass flow rate sensor data 161, the data processing system 175 can derive various parameters and generate associated parameter values such as shown in the chart 199 of FIG. 3 depicting types of fundamental parameters and their derived performance characteristics.

For example, based on stove mass sensor readings received over a time of operation, the data processing system 175 can detect a rate of change of the stove mass/weight. Based on the rate of change of the stove weight from sensor data 131, the system 175 can then derive a total wood burning heat release parameter value 183. Additionally, based on an addition of both the sensed flue gas temperature 141 and the sensed air mass flow rate data 161, the system 175 derives a heat loss parameter value 186 representing a heat loss through the chimney. Further, based on a difference between the total wood burning heat release parameter value 183 and the heat loss through the chimney value from data 186 the system derives a heat release parameter value 189 representing both the total wood burning heat released to the immediate stove environment, e.g., room where the stove is located. Further, based on a value computed by dividing the heat release parameter value 189 by the total wood burning heat release value 183, the system derives a real-time wood burning efficiency value 191. Further, based on an addition of both the sensed air mass flow rate from data 161 and the derived total wood burning heat released 183, the system derives a combustion stoichiometry parameter value 193. Further, as shown in FIG. 3, based on flue gas temperature sensor readings received over a time of operation, the data processing system 175 can detect a rate of change of the flue gas temperature. Then, based on an addition of the computed rate of change of the flue gas temperature data with to the stove weight data 151, the system derives a wood water content parameter value 197 (e.g., just after refuel).

### Methods and Procedures

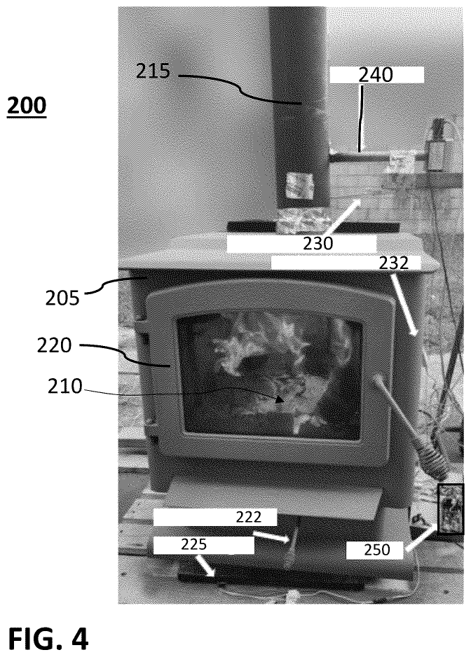

A woodboring stove apparatus 200 in accordance with an experimental use is shown in FIG. 4. In FIG. 4, a cordwood stove, e.g., an Englander 30-NC cordwood stove, having a jacket or housing 205 that defines a firebox or wood burning chamber 210 accessible via a housing door 220. In a non-limiting example, a wood burning chamber 210 volume is about 0.1 m³ (3.5 ft³). The stove apparatus 200 can include a bottom grating (not shown) for holding natural wood to be burned. A primary air feed (not shown) can draw air into the stove and up through the bottom grating to facilitate and control wood burn. Stove 200 is provided with an exhaust stack 215 adapted for connection with a known flue system, e.g., or a chimney system (not shown), for conducting exhaust materials and combustion gases. A non-limiting example stack diameter is about 15 cm (6 in). Primary air input to the firebox chamber 210 through a primary air feed is controlled through the use of a manual push rod 222 or similar air inlet control located at the front of the stove. In an embodiment, the air inlet control 222 is operated to control an amount of air input to a primary air feed in order to obtain a desired wood (fuel) burn rate. As shown, a stack thermocouple sensor 230, e.g., ⅛″ standard K-Type thermocouple accurate to +/−2.2 C°, is utilized to measure the flue gas temperature in the stack and an identical thermocouple sensor 232 is utilized to measure the stove jacket temperature. The stove weight was measured utilizing eight (8) strain gauge sensors 225. In a non-limiting embodiment, the strain gauge sensors 225 can be 50-kg strain gauge load cells with 0.1% full-scale accuracy and are attached to a flat board mounted at the bottom of the stove. Each strain gauge load cell sensor data can be communicated to and processed by a 24-bit analog-to-digital converter (ADC). The stove apparatus can utilize a high-temperature vane anemometer 240 (e.g., a Hontzsch ZS25/25-350GFE/500/p10/ZG4) in the stack 215 and assumes continuity to calculate an inlet air supply. Alternatively, anemometer sensor sensors can be located on the air inlet side in of the stove apparatus. A further sensor may include passive door sensor for detecting an open door condition, e.g., a limit switch or magnetic proximity sensor. A microcontroller control circuit board 250 including a processor, a memory, digital input/output pins, analog inputs, hardware serial data ports, a crystal oscillator, a USB connection, a power jack, etc., is provided and is configured to interface with each of the sensors and output the data, e.g., via a serial communication to an external computer device to record the data.

In the example use scenario, there can performed the following method. Initially, at a “cold-start” phase, the air inlet control is fully opened and a small amount of kindling, e.g., crumpled newspaper, can be placed in the center of the stove. Kindling and small pieces of wood are then placed around the paper, e.g., in a pyramid configuration. The starter fuel (wood) is then ignited and the door closed such that an interior handle makes contact with the outer side of the stove when rotated. This acts to provide a constant exterior inlet area into the combustion chamber during the startup phase. Fuel is then added as the fire progresses, with the last initial charge added as the flue gas temperature hits a predetermined level, e.g., 176 C.° (350 F°). The fuel door is then closed and the primary air inlet adjusted to the desired burn rate. An exemplary burn rate is approximately 3.6 kg (8 lb.) per hour during the steady-state burn phase.

Subsequent to the initial cold-start, an additional refueling phase can be performed. For example, after about one hour, additional fuel can be added to the stove. An adjustment of the inlet air control can be performed at the 150 minute mark, for example. The refueling event showcases that the data collected during this phase is distinct from those data collected during cold-start, and the wood burn emission control algorithm can vary as each “phase” will require different air control strategies. The fuel is then allowed to burn completely until the jacket temperature began to approach ambient temperatures, e.g., at the conclusion of the example scenario.

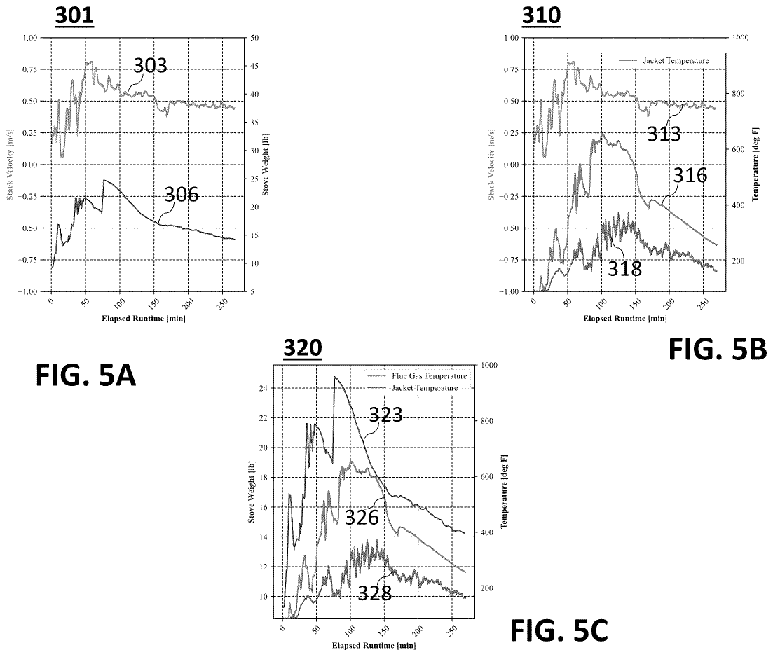

FIGS. 5A-5C show example stack velocity, stove weight, and stove temperature trends over a representative burn case.

As shown in FIG. 5A, there is depicted a graph 301 depicting a trend 303 relating the stove flue stack velocity (air emissions through the flue in m/sec² valued along the left Y-axis) as a function of time (X-axis) and a corresponding plot of a trend 306 correlating the stove weight over an elapsed time of a representative burn case.

FIG. 5B depicts graphs 310 showing a trend 313 relating the stack velocity (air emissions through the flue) as a function of time (X-axis), and a corresponding plot 316 depicting the corresponding real-time sensed flue gas temperature (e.g., degree values along the right Y-axis) as a function of time and a corresponding plot 318 depicting the corresponding real-time sensed stove jacket temperature as a function of time over a representative burn case.

Similarly, FIG. 5C depicts graphs 320 showing a trend 323 relating a stove weight (in lbs. valued along the left Y-axis) as a function of time (X-axis), and a corresponding plot 326 depicting the corresponding real-time sensed flue gas temperature (e.g., degree values along the right Y-axis) as a function of time and a corresponding plot 328 depicting the corresponding real-time sensed stove jacket temperature as a function of time over a representative burn case.

The traces in FIGS. 5A-5C illustrate the relationships between the minimal set of parameters selected. For example, as shown in FIGS. 5A-5C, flue gas and jacket temperatures appear to trend together, albeit with some initial lag-time. This shift in response time is likely due to the layers of insulation between the combustion chamber and jacket, which slows down the heat transfer rate, whereas the flue gas temperature is a more direct measurement. There is also more granularity with the flue gas temperature measurement, which may show changes in behavior that the jacket temperature may otherwise not predict. Therefore, decisions that require fast response time are likely best suited to utilize the flue gas temperature. However, the jacket temperature is still important for determining operation mode, as the flue gas temperature on its own is not enough. For example, a rapidly increasing flue gas temperature may be indicative of a cold start-up or refueling phase. When combined with the jacket temperature, it is clear that when combined with a jacket temperature close to ambient, this would be categorized as a start-up phase, while when the jacket temperature is steady and hot, it is a refueling phase. Experimental records and stove weight data verify this determination from temperatures alone.

Similarly, the stove weight measurement brings additional information. When fuel consumption begins to slow and flue gas temperatures decrease below a certain threshold, a smoldering or burnout case may exist. Additionally, the slope of the weight curve in conjunction with the flue gas temperature may be used to indicate the drying phase and estimate the initial moisture content of the wood. This phase distinction is important as it may impact the amount of air required to be supplied to the combustion chamber as compared to a steady-state burn due to the difference in the apparent mass change (water or fuel). This is also critical for the determination of other performance characteristics, such as the heat release rate and eventual heat output to the room.

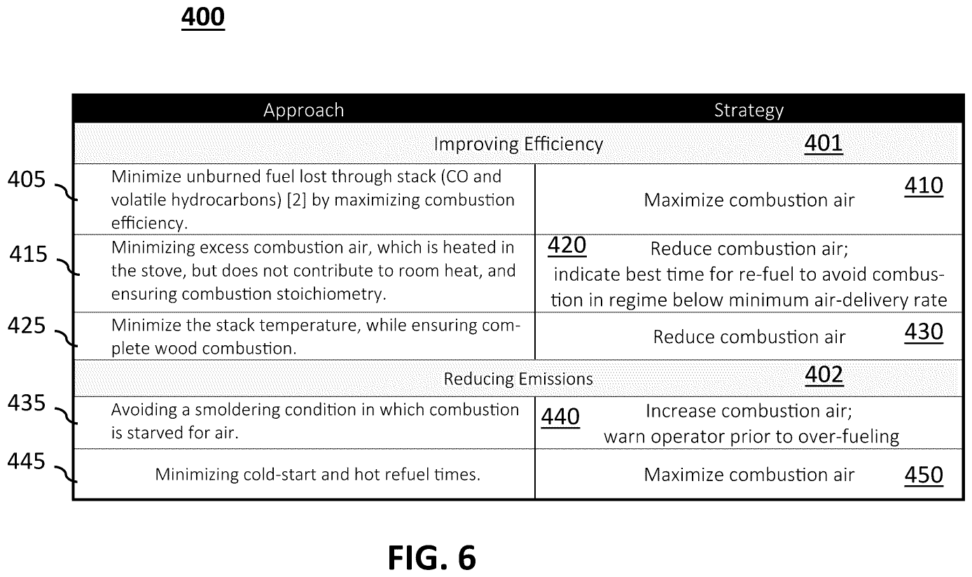

FIG. 6 depicts a chart indicating the approach 400 for developing a method for controlling biomass heater/stove operations to effect maximized burning efficiency with minimized emissions. As shown, an approach 401 includes improving efficiency of biomass heater/stove operations. For example, as shown at 405, one of the modeled approaches for improving burning efficiency is to minimize unburned fuel lost through the stack (e.g., of CO and volatile hydrocarbons) by maximizing combustion or “conversion” efficiency (where conversion is more general as burning is a type of oxidation or burning). A corresponding automated control step taken would be to maximize the amount of combustion air as indicated at 410. Further, as shown at 415, one of the modeled approaches for improving burning efficiency is to minimize excess combustion air, which is heated in the stove, but does not contribute to room heat, and ensuring combustion stoichiometry. A corresponding automated control step taken would be to reduce combustion air, and in addition, indicate a best time for re-fuel to avoid combustion in regime below minimum air-delivery rate as indicated at 420. Further, as shown at 425, one of the modeled approaches for improving burning efficiency is to minimize the stack temperature while ensuring complete wood combustion. A corresponding automated control step taken would be to reduce combustion air as indicated at 430.

As further shown in FIG. 6, further to the approach 400 for developing a method for controlling biomass heater/stove operations includes an approach 402 for reducing particulate emissions of biomass heater/stove operations. For example, as shown at 435, one of the modeled approaches for improving reducing PM emissions is to avoid a smoldering condition in which combustion is starved for air. A corresponding automated control step taken would be to increase the amount of combustion air as indicated at 440 and provide a warning to the operator prior to over-fueling. Further, as shown at 445, one of the modeled approaches for reducing emissions is to minimize the cold-start and hot refuel times. A corresponding automated control step taken would be to maximize combustion air as indicated at 450.

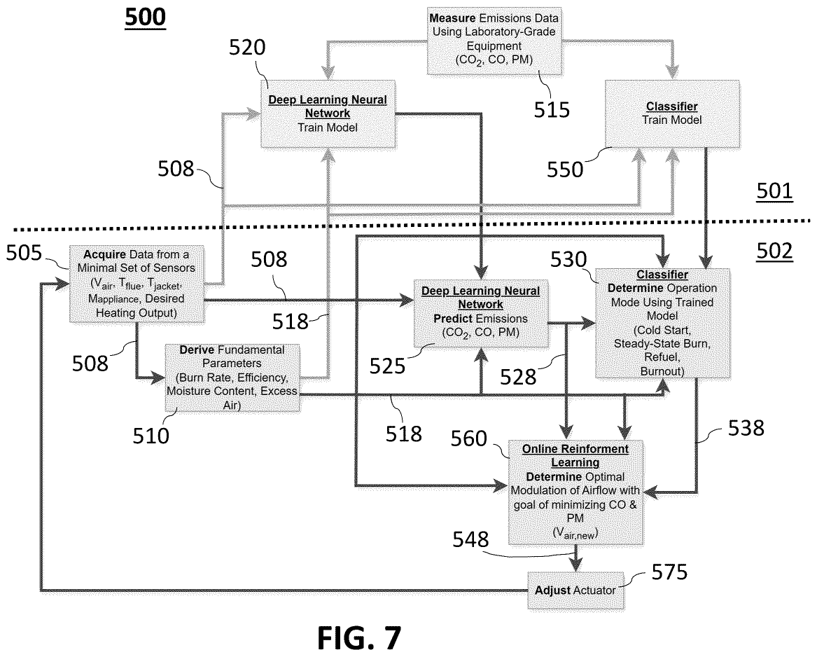

FIG. 7 depicts an approach for developing a method 500 for controlling biomass heater/stove operations to maximize burning efficiency with minimum emissions at a wood burning stove using a minimum of sensing parameters. The method 500 of FIG. 7 provides the run-time model for controlling biomass heater/stove operations for effecting maximized burning efficiency with minimized emissions based on the approaches shown in FIG. 6. In an embodiment, the method implements a combination of Deep Learning Neural Networks (DNN), machine learned classification models, and reinforcement learning to allow for a continuous prediction of emissions and operation mode, as well as appropriate airflow actuator adjustment, due to its ability to adapt to new situations outside of the scope of a lookup table. Processing to train the DNN model is depicted along flow paths 501 while real-time DNN processing and use of the model is depicted along flow paths 502.

As shown in FIG. 7, the real-time model flow paths 502 can be run used to automatically control and optimize wood burning operations at a wood burning stove using a minimum of sensing parameters. At an initial step 505, it is assumed the appliance has been set, e.g., by a user, to a desired heating output as one of: LOW, MEDIUM, or HIGH for example. This is required to meet several common cases that occur in using biomass combustion devices, such as an immediate demand for heat or a slow, longer duration burn (such as an overnight load). The device then records data from a minimal set of sensors, which may include: air flowrate (Vₐᵢᵣ), Flue temperature (T_{flue}) and Jacket temperature (T_{jacket}), and the mass of the stove or appliance (M_{appliance}). This sensing occurs continuously in the field and processing flow paths are depicted in FIG. 7.

At a next processing shown at 510, there is depicted the combining of the acquired raw sensor data 508 and using energy and mass conservation laws to produce parameters 518 fundamental to the operation and performance of the appliance, such as burn rate (e.g., kg/hr), heating efficiency (%), fuel moisture content (%), and excess air ratio. This process occurs continuously in the field and the particular functional real-time processing flow paths are depicted at 502.

Furthermore, in a laboratory setting, at 515, FIG. 7, high-accuracy emissions analyzers can record the real emissions (CO₂, CO, and Particulate Matter concentrations) in conjunction with the acquired sensor data 508 and derived fundamental parameters 518 described in steps 505, 510. This data 508, 518 is divided into training and test datasets. Then, at 520, FIG. 7, a Deep Learning Neural Network (such as an Artificial Neural Network (ANN)) is then trained and validated. Then, at 525, the DNN model is then loaded onto the controller device associated with the stove appliance with the goal of predicting emissions 528 (e.g., CO₂, CO, and Particulate Matter in grams/hour for example) based on the acquired real-time sensor data 508 from the appliance and also based on the derived fundamental parameters 518 from processing block 510. The DNN model requires training only once and is thus depicted using flow paths 501. Besides predicting at 525 the emissions 528 based upon the raw data and parameters derived from steps 505, 510, a further classifier model 550 is trained to determine an operation mode of the appliance at 530. That is, based on the acquired real-time sensor data 508 and derived parameters 518, and the predicted emissions 528 from the DNN, the classification model is additionally trained for use at 530 to classify/determine the operational mode 538 of the appliance, i.e., whether the stove is at a cold start, a steady-state burn, a refuel state, or a burnout state.

Referring to the processing paths 501, FIG. 7, there is depicted the training of the DNN at 520 wherein a computing system obtains from a first path 508 the raw Vₐᵢᵣ, T_{flue}, T_{jacket}, and M_{appliance} data acquired from the minimal set of sensors at 505 and including the parameters derived 518 therefrom at 510 which parameters 518 are received to train the DNN at 520. In a laboratory setting, the received parameters from 518, and the real emissions recorded at 515, arc tagged with labels to indicate the operation mode of the device: cold start, steady-state burn, refuel, and burnout. The data is then divided into training and test datasets for use in training the DNN 525 for use in correlating particular parameters and sensed raw operating conditions to a particular operational mode and predicting emissions.

That is, at block 550, along the model training flow paths 501, processes are run to generate, train and validate the Classification Model 550 which can be but not limited to one of: a Support Vector Classification (SVC), a k-Nearest Neighbor (KNN), or a Decision Tree (DT) model 530. This classification model 530 is also loaded onto the microcontroller device associated with the stove, where a program is run for predicting the operation mode of the device from the raw sensor data 508 in the field and the derived parameters 518. The model requires training only once and is thus depicted using flow paths 501.

Once the raw sensor data values 508, derived parameter values 518, the DNN model predicted amount of emissions 528 obtained in step 525, and the classified current stove operation mode 538 determined by the classifier model at 530 are available, an Online Reinforcement Learning (ORL) tool 560 is run to determine the correct adjustment of the supply air that minimizes CO and PM emissions for the given required heating output—wherein “Online” refers to the interaction between the model and its environment and updates itself accordingly by rewarding actions that result in a more optimal state. That is, in an embodiment, the ORL tool receives the current derived parameter values 518, the DNN model predicted amount of emissions 528 and the current predicted stove operating mode 538 to generate an optimal airflow value that achieves a goal of minimizing CO and PM produced by the stove appliance. Further, the ORL tool 560 generates a “new” volume of air value (e.g., Vₐᵢᵣ, new) 548 and this value is correlated or mapped to a particular actuator adjustment value 575 so that the stove appliance can dynamically and automatically adjust the actuator to ensure receiving the correct amount of airflow, given the current conditions/parameters. That is, an electronic signal 580 can be generated in real-time as feedback to an actuator that responsively adjusts or modulates the flow of air to the stove combustion chamber. For example, in order to achieve a specified excess air-ratio for favorable combustion there is required an optimum required oxygen supply rate. Variable application of combustion air allows an operator to impact the turbulence in the combustion chamber (e.g., better mixing), as well as the residence time of the gases (e.g., increase flow rate, reduce residence time; providing more time for intermediate reactions to take place, etc.).

It is understood that the processes represented by flow paths 501, 502 depicted in FIG. 7 repeats continually by returning to step 505.

In an embodiment, while conventional Proportional-Integral-Derivative (PID) control can be implemented to control or adjust the actuator, the real-time approach of FIG. 7 taken for the actuator adjustment differs from the conventional PID control used in existing techniques. PID control is often tuned according to a desired outcome once-whereas the weights and biases of the reinforcement model can be updated over the usage of the device and be specific to a particular installation without manual intervention. As the device ages and soot begins to develop, the model can adapt its weights to a new space of possible airflow adjustments and take corrective action, whereas a PID controller may attempt to achieve a no-longer possible operating point.

In an embodiment, the method implements an approach utilizing a combination of Deep Learning Neural Networks, Classification Models, and Reinforcement Learning to allow for a continuous prediction of emissions and operation mode, as well as appropriate actuator adjustment, due to its ability to adapt to new situations outside of the scope of a lookup table. Furthermore, based on the processing shown in the method 500 of FIG. 7.

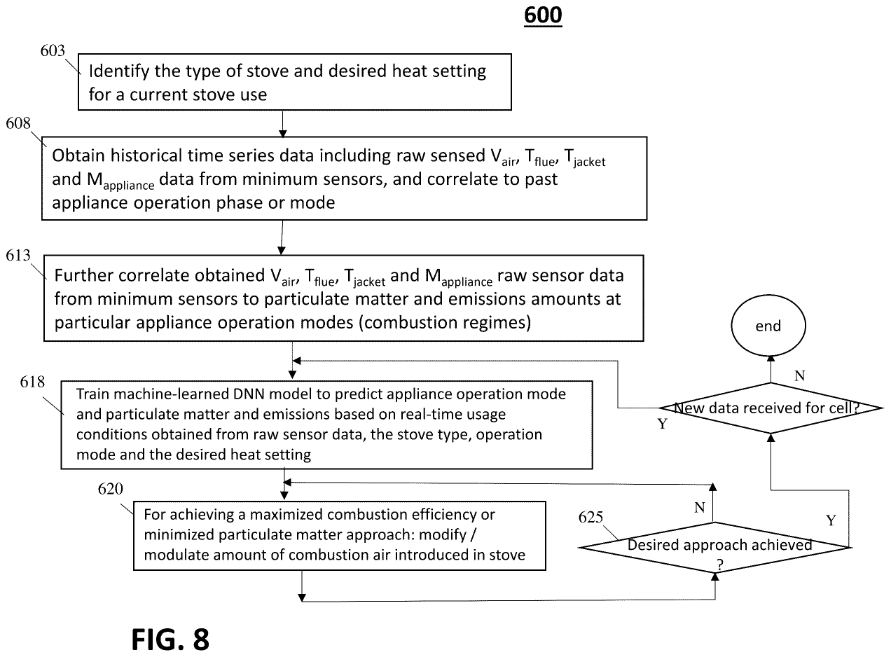

FIG. 8 depicts a further process 600 for generating a wood burn emission control model for predicting particulate emissions for particular stove settings and provide reinforcement learning for taking a corrective approach to optimize combustion and minimize generating particulate matter at the stove. At a first step 603, there is first identified a stove heat setting (e.g., low medium, high), a type of stove and the biomass fuel, e.g., wood type and amount, being burned. Then, at 608 there is obtained time series data for the current and past historical and/or experimental uses of the stove that includes, the heat settings, the type of stove, the type and amount of wood being burned and the time of wood combustion that has elapsed, e.g., an operation mode or phase like cold start-up, steady-state burn, refuel, smoldering, burnout and cool down. These data are correlated with the raw data Vₐᵢᵣ, T_{flue}, T_{jacket} and M_{appliance} data acquired from the minimal set of sensors. At such time, laboratory equipment can also be used to measure the emissions of such fuel combustion so that the generated particulate matters and emissions data (e.g., CO, CO₂, CH4 and PM) and are also correlated to the particular operation mode or phase of the stove.

Then, at 613, FIG. 8, there is further correlated the sensed raw data Vₐᵢᵣ, T_{flue}, T_{jacket} and M_{appliance} data acquired from the minimal set of sensors with the particulate matter and emissions amounts at the particular detected stove operating mode or phase (combustion regime). Then, at 618, based on these data correlations, a deep neural network or like machine learned model is trained so that the model can predict a particular amount of particulate matter and stove emissions based on a detected operating mode or phase and the raw sensor data. Based on the approaches of FIG. 6., a determination can be made to ascertain whether the burning efficiency can be maximized and particulate matter emissions minimized. For example, at 620, to achieve maximized burning efficiency or reduced particulate matter emissions, the stove can be operated to dampen air flow or introduce additional combustion air into the stove combustion chamber. Then, at 625, a decision is made as to whether the air modification introduced at 620 was sufficient to achieve the requested approach to maximize burning efficiency and/or minimize particulate matter emissions. If the approach taken was insufficient, the process returns to 620 to further modify/modulate amount of combustion air introduced to the wood-burning stove and these steps 620, 625 will repeat. Once the desired approach is achieved, the method continues at 630 to determine whether a new stove use has occurred/is occurring. If there is a new stove use that has occurred/is occurring, the method returns to step 618 to use the newly acquired raw data to further train the prediction model at 618, and the process repeats. If however, at 630, it is determined no new stove use has occurred/is occurring, the method will end and the trained model is run at the microprocessor or like controller used at the stove for controlling wood burning efficiency/minimizing particulate emissions.

Thus, embodiments of the system and method provide an intelligent stove that utilizes a minimal set of measurement sensors and a control strategy to actively modulate incoming air, enhancing stove combustion performance, thereby eliminating user-error as a factor for emissions production. Critical performance metrics such as the heat release rate, instantaneous stove efficiency, combustion stoichiometry and wood moisture content can all be estimated using combinations of the stove temperature, weight and airflow rates. These parameters are then used in a feedback control algorithm to optimize the variable application of combustion air as well as reduce the burden on the operator by providing recommendations for refueling and replacement of components through automated, intelligent decision-making.

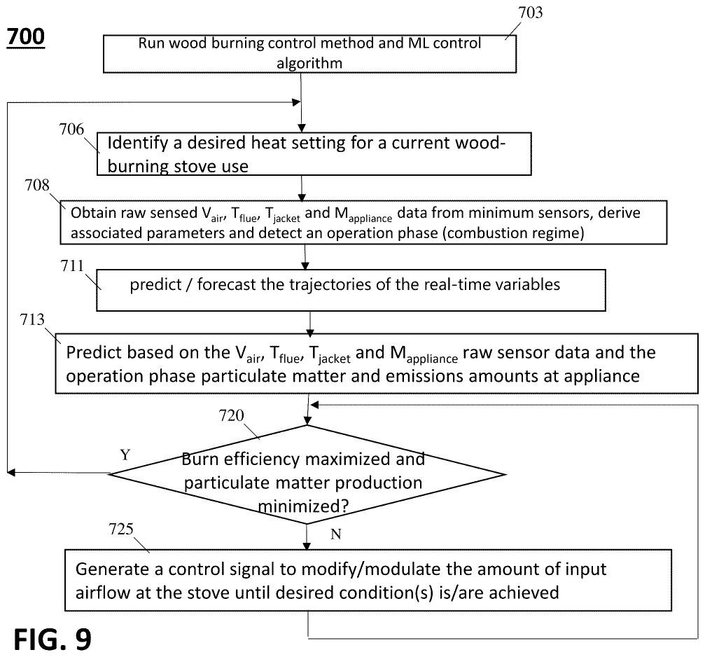

FIG. 9 depicts an exemplary method 700 for wood burn stove emission control for implementing a corrective approach to optimize combustion and minimize generating particulate matter at the stove. As shown, initially at 703, the wood burning control method and machine learned prediction algorithm is run at the stove microprocessor, e.g., the Arduino® Mega. At 706, the controller identifies a desired heat setting for a current wood-burning stove use. Then, at 708, the minimal set of sensor devices at the stove produce and the microprocessor obtains raw sensed Vₐᵢᵣ, T_{flue}, T_{jacket} and M_{appliance} data from the sensors. Continuing to 711, generation of these corresponding sensor signals is an outcome of prediction that occurs. That is, the system is configurable to generate a forecasted or expected real-time biomass operating condition/parameter trajectory (predict expected performance) based on the history of past captured real-time biomass operating conditions. For example, the real time sensor readings coupled with the history of these real-time measurement can be used to predict the expected performance of the real-time measurement and then correct this expected performance to provide a predictive-based control. From these values, the microprocessor can derive associated parameters and detect the current operation phase (combustion regime). Then, at 713, the method predicts based on the Vₐᵢᵣ, T_{flue}, T_{jacket} and M_{appliance} raw sensor data and the operation phase, the particulate matter and emissions amounts currently being generated at the stove appliance. Then, at 720, a determination is made as to whether the wood/fuel burn efficiency has been maximized and whether the particulate matter produced is minimized. If it is detected that the wood/fuel burn efficiency has been maximized and the particulate matter produced is minimized, then the process returns to 706 so that the method can continue real-time monitoring operations.

Otherwise, at 720, if it is detected that the wood/fuel burn efficiency has not been maximized and the particulate matter produced is not minimized, then the process continues to 725 where the controller generates a control signal to modify/modulate the amount of input airflow at the stove until desired condition(s) is/are achieved. The signal generated is a predictive-based control signal for modifying an amount of combustion air introduced or other critical combustion operating parameter for biomass combustion at said biomass combustion appliance. The amount of combustion air or other critical combustion operating parameter modified in a manner to improve a stove burning efficiency or reduce particulate emissions produced by the biomass combustion. The process then will return to step 720 to make this determination and the steps 720-725 are repeated until the wood/fuel burn efficiency has been maximized and the particulate matter produced is minimized.

The system and method can be utilized in biomass space heating products including residential wood stoves, residential or commercial wood boilers, recreational and commercial food smokers (similar temperature operation and fuel reloading requirements), as well as biomass or coal fired steam power generation (similar temperature control and fuel reloading requirements).

The system and method further includes intelligent engineering decision driven automation and control throughout the entire burn cycle. With the intelligent automation and control system of the disclosed embodiments, the system and method provides a full, optimized start-up, steady-state burn, a wet-wood drying phase, a door open phase, smoldering phase, and a burnout phase with targeted conditions of maximizing heat delivered while minimizing emissions.

Overall, the present disclosure provides for a minimal set of measurements allowing for the determination of operating mode and is promising for computing performance characteristics and recommendations for operators.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus for controlling a biomass combustion appliance, the apparatus comprising:
one or more sensor devices associated with the biomass combustion appliance, said one or more sensor devices placed at predetermined locations on the biomass combustion appliance for sensing real-time biomass conversion operating conditions and generating corresponding sensor signals;
a hardware processor configured to receive said real-time sensor signals associated with said real-time biomass fuel conversion operating conditions, predict the trajectory of one or more real-time sensor signals and derive performance characteristic parameters associated with a current biomass fuel combustion operating condition based on said real-time sensor signals, and
the hardware processor further configured to generate, based on the derived performance characteristic parameters and predicted trajectory of the one or more real-time sensor signals, a predictive-based control signal for modifying an amount of combustion air introduced for biomass combustion at said biomass combustion appliance, said amount of combustion air modified in a manner to achieve a desired combustion operation.

2. The apparatus as claimed in claim 1, wherein the derived performance characteristic parameters comprise one or more of: a total biomass combustion heat release rate, a heat release to a room, an instantaneous real appliance efficiency, a combustion stoichiometry and a biomass fuel moisture content.

3. The apparatus as claimed in claim 2, wherein the appliance is connected to a flue adapted to allow biomass combustion gaseous and solid particle (smoke) emissions to escape through an external opening, said derived performance characteristic parameters further comprising a heat loss through said flue.

4. The apparatus as claimed in claim 1, wherein the wood burning stove comprises an air flow damper adapted to modify an amount of combustion air introduced to biomass combustion appliance, said control signal automatically controlling an actuator for modifying an opening of said air flow damper.

5. The apparatus as claimed in claim 4, wherein the biomass combustion appliance includes a DC servo motor connected to the combustion air flow damper or flue damper or combination of both to modulate a combustion airflow.

6. The apparatus as claimed in claim 1, wherein the biomass combustion appliance includes an actuation device to modulate a damper or an electrified DC servo connected to a variable speed axial fan to modulate combustion airflow.

7. The apparatus as claimed in claim 3, wherein one or more sensor devices comprise: a temperature sensor for sensing a real-time temperature condition of a housing defining a biomass combustion chamber at said appliance, the sensor condition corresponding to a temperature of combustion at said biomass combustion chamber, a further temperature sensor for sensing a real-time temperature condition of said flue, an airflow mass sensor for sensing an airflow at an air inlet to said appliance, and a appliance mass sensor for sensing a weight of the biomass combustion appliance in real-time.

8. The apparatus as claimed in claim 7, wherein the hardware processor is further configured to: detect, based on said received said real-time sensor signals, a current real-time operating phase of said biomass combustion appliance operation, an operating phase comprising one or more of: a cold-start up phase, a wet-wood drying phase, a steady state wood burning phase, a refueling phase, a hot restart phase, a wood smoldering phase, a cool down condition, a door open condition.

9. The apparatus as claimed in claim 8, wherein the hardware processor is further configured to implement one or more: proportional (P), proportional-integral (PI), proportional-integral-derivative (PID), or machine learning (ML) based control method to generate the control signal to modify an amount of combustion air introduced into said appliance responsive to a biomass combustion efficiency threshold or an emissions level or other user defined target performance objective threshold and the current operating phase and the predicted performance path and the derived performance characteristics.

10. The apparatus as claimed in claim 8, wherein the hardware processor is further configured to implement a heuristic control algorithm to generate the control signal to modify an amount of combustion air or other critical operational parameter(s) introduced into said appliance responsive to a detected biomass combustion appliance operating phase and current real-time derived performance characteristic parameters.

11. The apparatus as claimed in claim 8, wherein the hardware processor is further configured to:
run an artificial intelligence (AI) driven machine learning (ML) based model to identify, based on the current derived performance characteristic parameters, a control option used to modify an amount of combustion air introduced or other critical operational parameters for biomass combustion at said biomass combustion appliance, said control option designed to one or more of: increase a biomass burning efficiency measure or decrease an emissions measure, wherein said machine learned model is trained to correlate prior performance characteristic parameters derived from past biomass combustion appliance operation conditions and detected operating phases with a particular biomass combustion efficiency measure or optimized emissions measure.

12. The apparatus as claimed in claim 1, wherein said hardware processor is further configured to: generate an output recommendation to refuel the biomass combustion appliance by adding additional biomass fuel for combustion in a pre-determined sequence to the biomass combustion appliance.

13. A method for controlling a biomass combustion appliance, the method comprising:
sensing, using one or more sensor devices placed at predetermined locations on a biomass combustion appliance, real-time biomass combustion operating conditions and generating corresponding sensor signals;
receiving, at a hardware processor, said real-time sensor signals associated with said real-time biomass combustion operating conditions;
predicting, by the hardware processor, the trajectory of one or more real-time sensor signals;
deriving, by said hardware processor, performance characteristic parameters associated with a current biomass combustion operating condition based on said real-time sensor signals, and
generating, based on the derived performance characteristic parameters and predicted trajectory of the one or more real-time sensor signals, a control signal for modifying an amount of combustion air introduced for wood combustion or other critical combustion operational parameter(s) at said biomass combustion appliance; and
modifying, responsive to said generated control signal, said amount of combustion air or other critical combustion operational parameter(s) in a manner to achieve a desired combustion operation.

14. The method as claimed in claim 13, wherein the derived performance characteristic parameters comprise one or more of: a total biomass combustion heat release rate, a heat release to a room, an instantaneous real combustion appliance efficiency, a combustion stoichiometry and biomass moisture content.

15. The method as claimed in claim 14, wherein the stove is connected to a flue adapted to allow biomass combustion gas and gaseous or solid particulate emissions to escape through an external opening, said derived performance characteristic parameters further comprising a heat loss through said flue.

16. The method as claimed in claim 13, wherein the biomass combustion appliance comprises an air flow damper adapted to modify an amount of combustion air introduced to the biomass combustion appliance, said control signal automatically controlling an actuator for modifying an opening of said air flow damper.

17. The method as claimed in claim 16, wherein the biomass combustion appliance includes an actuator connected to the air flow damper, said method further comprising, using said control signal to modulate a combustion airflow.

18. The method as claimed in claim 13, wherein the biomass combustion appliance includes a DC servo connected to a variable speed axial fan, said method further comprising, using said control signal to modulate a combustion airflow.

19. The method as claimed in claim 15, wherein one or more sensor devices comprise: a temperature sensor for sensing a real-time temperature condition of a housing defining a biomass combustion chamber at said appliance, the sensor condition corresponding to a temperature of a combustion at said biomass combustion chamber, a further temperature sensor for sensing a real-time temperature condition of said flue, an airflow mass sensor for sensing an airflow at an air inlet to said stove, and an appliance mass sensor for sensing a weight of the appliance in real-time.

20. The method as claimed in claim 19, further comprising:
based on said received said real-time sensor signals, detecting, using the hardware processor, a current real-time operating phase of said biomass combustion appliance operation, an operating phase comprising one or more of: a cold-start up phase, a wet-wood drying phase, a steady state wood burning phase, a refueling phase, a hot restart phase, a wood smoldering phase, a cool down condition, a door open condition.

21. The method as claimed in claim 20, further comprising:
configuring the hardware processor to implement a proportional-integral-derivative (PID) control method to generate the control signal to modify an amount of combustion air introduced into said appliance responsive to a biomass combustion efficiency threshold or a gaseous or solid particulate emissions level threshold and the current operating phase, derived performance characteristics, and predicted performance path.

22. The method as claimed in claim 20, further comprising:
configuring the hardware processor to implement a heuristic control algorithm to generate the control signal to modify an amount of combustion air introduced into said appliance responsive to a detected biomass combustion appliance operating phase and current real-time derived performance characteristic parameters as well as the predicted performance path of the current operating phase as well as the predicted performance of the current real-time derived performance characteristic parameters.

23. The method as claimed in claim 20, further comprising:
running, at the hardware processor, a machine learned model to identify, based on the current derived performance characteristic parameters, a control option used to modify an amount of combustion air introduced for biomass combustion at said biomass combustion appliance, said control option designed to one or more of: increase a biomass combustion efficiency measure or decrease an emissions measure, wherein said machine learned model is trained to correlate prior performance characteristic parameters derived from past biomass combustion stove operation conditions and detected operating phases with a particular biomass combustion efficiency measure or optimized emissions measure.

24. The method as claimed in claim 13, further comprising:
generating, by said hardware processor, an output recommendation to refuel the biomass combustion appliance by adding additional biomass for combustion in a pre-determined sequence to the biomass combustion appliance.

25. A computer program product for controlling a biomass combustion appliance, the computer program product comprising:
one or more computer readable storage media, and program instructions collectively stored on the one or more computer readable storage media, the program instructions comprising:
program instructions configuring the hardware processor to receive from one or more sensor devices associated with the biomass combustion appliance, real-time sensor signals associated with a real-time biomass combustion operating condition, predict the trajectory of one or more real-time sensor signals and to derive performance characteristic parameters associated with a current biomass combustion operating condition based on said real-time sensor signals, said one or more sensor devices placed at predetermined locations on appliance for sensing the real-time biomass combustion operating conditions;
program instructions configuring the hardware processor to generate, based on the derived performance characteristic parameters and predicted trajectory of the one or more real-time sensor signals, a control signal for modifying an amount of combustion air introduced for biomass combustion at said biomass combustion appliance, said amount of combustion air modified in a manner to achieve a desired combustion operation.
